(19) United States
(12) Patent Application Publication
(10) Pub. No.: US 2025/0209187 A1
(43) Pub. Date: Jun. 26, 2025

(54) AI LEARNING SYSTEM

(71) Applicant: Toyota Jidosha Kabushiki Kaisha, Toyota-shi (JP)

(72) Inventors: Tomokazu ISHII, Okazaki-shi (JP); Masaya Fujimori, Susono-shi (JP); Yosuke Ueno, Nagoya-shi (JP)

(73) Assignee: Toyota Jidosha Kabushiki Kaisha, Toyota-shi (JP)

(21) Appl. No.: 18/940,044

(22) Filed: Nov. 7, 2024

(30) Foreign Application Priority Data
Dec. 20, 2023 (JP) 2023-215135

(51) Int. Cl. G06F 21/60; G06F 21/62

(52) U.S. Cl. CPC G06F 21/602; G06F 21/6245

(57) ABSTRACT

An AI learning system comprising: a sorter configured to sort, from among AI learning data, personal information that should be secret when creating a desired AI model, according to prescribed criteria; an encryptor configured to encrypts the sorted personal information;
a holder configured to hold the AI learning data including the encrypted personal information in a blockchain; and an AI learner configured to perform secret calculations on at least the data portion related to encrypted the personal information to learn the AI model, using the stored AI learning data; wherein the sorting unit sets the prescribed criteria so as to reduce amount of calculation processing, depending on the degree of increase or decrease in the amount of calculation processing of the secure computation due to encryption of the personal information and the degree to which the personal information should be secret.

### CROSS-REFERENCE TO RELATED APPLICATIONS

This application is based upon and claims the benefit of priority of the prior Japanese Patent Application No. 2023-215135, filed on Dec. 20, 2023, the entire contents of which are incorporated herein by reference.

### BACKGROUND

### 1. Technical Field

The present invention relates to a technical field of an AI learning system that executes AI learning based on AI learning data relating to personal information while concealing personal information.

### 2. Description of the Related Art

As AI learning system of this type, in addition to traditional AI learning systems such as a so-called supervised learning method, an unsupervised learning method, or an automated driving of a reinforcement learning method, a system for various applications such as a generation AI has recently been developed and practically used (refer to Japanese Patent Application Laid Open No. 2019-212248 (Patent Literature 1)). AI learning-data used in such systems may include personal information, depending on the field. For this reason, under the Personal Information Protection Law and the General Data Protection Rules in GDPR (General Data Protection Regulation: EU), personal information must be encrypted or secret so that individuals cannot be identified easily.

### SUMMARY

According to Background Art described above, efficient resource driving can be achieved to maintain a blockchain network. However, according to the Background Art described above, there is a technical problem in that it is difficult to carry out AI learning, while complying with requirements of Act on the Protection of Personal Information and/or GDPR, based on AI learning data that includes personal information in a state where personal information is secreted or concealed. For this reason, AI use of personal information has not progressed gradually.

It is an object of the present invention to provide AI learning system which enables AI learning using AI learning data including personal information, while complying with legal requirements related to personal information.

An AI learning system according to an example aspect of this disclosure comprising: a sorter configured to sort, from among AI learning data, personal information that should be secret when creating a desired AI model, according to prescribed criteria; an encryptor configured to encrypts the sorted personal information; a holder configured to hold the AI learning data including the encrypted personal information in a blockchain; and an AI learner configured to perform secret calculations on at least the data portion related to encrypted the personal information to learn the AI model, using the stored AI learning data; wherein the sorting unit sets the prescribed criteria so as to reduce amount of calculation processing, depending on the degree of increase or decrease in the amount of calculation processing of the secure computation due to encryption of the personal information and the degree to which the personal information should be secret.

According to an aspect of AI learning system according to the present invention, AI learning can be performed using AI learning data including personal information, while complying with a legal request such as a GDPR relating to personal information.

Such an action and effect according to the present invention will be more apparent from the embodiments of the invention described below.

### BRIEF DESCRIPTION OF THE DRAWINGS

FIG. 1 is a block diagram showing a total configuration of AI learning-system according to the embodiment.

FIG. 2 is a flow chart illustrating an exemplary processing in AI learning-system according to the embodiment.

FIG. 3 is a flow chart illustrating an exemplary AI learning processing among processing in AI learning system according to the embodiment.

FIG. 4 is a flow chart showing another exemplary AI learning processing among processing in AI learning system according to the embodiment.

### DETAILED DESCRIPTION OF THE EMBODIMENT

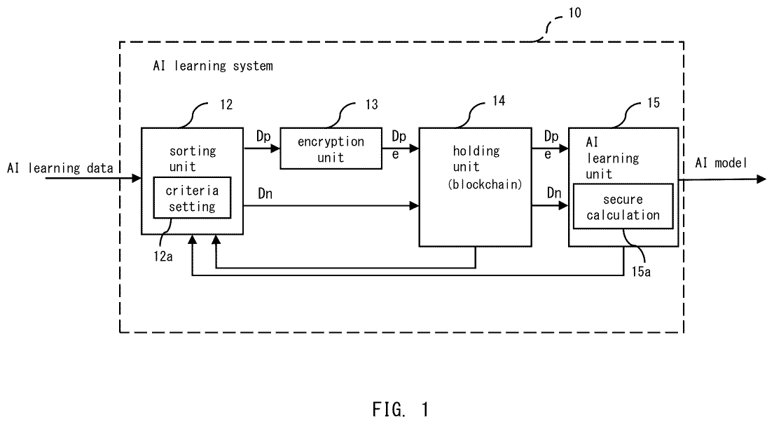

First, referring to FIG. 1, the entire configuration of AI learning-system according to the embodiment will be described. The present embodiment is constructed as a system that performs AI analyzes based on AI learning data including the personal information relating to, for example, elderly drivers, disabled people, patients, etc. Specifically, for example, the present embodiment is constructed as a system for providing customized analysis results to an individual, which is useful in determining whether or not an individual can be employed by the company, a place of employment, a place of assignment, and working hours, a treatment or treatment, and an automobile accident insurance premium. More generally, the present embodiment is applicable to AI studies that need to be conducted in accordance with legal requirements such as the Personal Information Protection Law and GDPR, and in either case, the protection of personal information can be enhanced.

As shown in FIG. 1, AI learning system 10 is configured as a system that performs centralized processing or distributed processing in which “AI learning data” is input or provided from a data source (not shown) housed in a network, and “AI models” obtained as a result of AI learning or AI analysis are output or provided to a model destination (not shown) housed in a network.

Incidentally, the source (not shown) is a various computer-mounted devices or various computer devices that perform centralized processing or distributed processing. The source (not shown) is configured to provide AI learning system 10 with the data format in which the input or collected data for processing by the source (not shown) is applied as it is or a predetermined type through a network.

Providing destination (not shown) are various computer-mounted devices that perform centralized processing or distributed processing and various computer devices. The providing device (not shown) is configured such that an AI modeled to be outputted or provided to a providing device (not shown) is provided to various kinds of business such as recruitment business, human business, insurance business, etc.

AI learning data related to the personal information may be personal information collected on the assumption that the consent of the person is obtained, such as the age, gender, date of birth, height, weight, blood type, various vital data, family history, family composition, school history, job history, professional experience, special skill, award, apprentice, address, location of origin, booklet, property status, certification photograph, driving license number, My number, etc. AI learning data related to personal information may include from general personal information to special personal information. Both in the case of general personal information and in the case of special personal information, the effect of the present embodiment to be described below is correspondingly achieved. Such personal information may be textualized or encoded in predetermined formats to the extent that it is capable of analyzing AI that is already or will be developed.

Alternatively, the personal information may be handwritten or by a mark sheet. Further, the personal information may be imaged information or visual information.

AI learning system 10 includes a memory, a processor, and the like, and is configured as a distributed system for performing a centralized processing or distributed processing. AI learning system 10 includes a sorting unit 12, an encryption unit 13, a holding unit 14, and an AI learning unit 15.

The sorting unit 12 is configured to sort the personal information data Dp that should be secret when creating a desired AI model from AI learning data, in accordance with prescribed criteria. The desired AI model may be, for example, an AI model for personnel evaluation or the like. Sorting unit 12 may have criteria setting unit 12a. The criteria setting unit 12a sets prescribed criteria so as to reduce the amount of calculation processing, depending on the degree of increase or decrease in the amount of calculation processing for secure computation and the degree to which the personal information should be secret.

Criteria setting unit 12a, for example, may be set prescribed criteria by human input by the operator. Alternatively, the criteria setting unit 12a may set prescribed criteria by inputting a function that is empirically determined in advance. The function input empirically determined in advance may be an input of a function that outputs the amount of computation processing using the degree of increase or decrease in the amount of computation processing of the secure computation and the degree to which the personal information should be secret as input. Alternatively, the criteria setting unit 12a may set prescribed criteria by referring to a map that specifies the three-party relationship between the degree of increase/decrease in amount of computational processing of the secure computation, the degree to which the personal information should be secret, and the amount of calculation processing. Alternatively, the criteria setting unit 12a may set prescribed criteria by AI learning.

When setting prescribed criteria by AI learning, for example, an operator may first enter one or more hyperparameters relating to processing amount of the secure computation and the secrecy of the personal information in order to set the prescribed criteria. AI may be configured to tune a hyperparameter previously set, i.e., to adjust the type or combination of parameters, during the learning process. In particular, the amount of computational processing for secure computation increased and/or decreased in a complex manner depending on the specific method and content of the computation. On the other hand, the degree to which personal information should be kept secret also changes in complex ways depending on the combination of individual elements that make up the personal information, such as whether or not an individual can be identified. Furthermore, the permissible range at which individuals permit their use for AI spectrometry may vary from one person to another. Therefore, hyper-tuning through AI learning is more effective than simply inputting a function or hyperparameters that output the amount of computational processing.

The criteria setting unit 12a may be configured to perform AI learning, such as a supervised learning method, an unsupervised learning method, a semi-supervised learning method, a reinforcement learning method, or a generative AI method, and to update the to be set. Alternatively, the criteria setting unit 12a that performs AI learning may be configured using a neural network that performs efficient AI learning through representation learning, transfer learning, feature selection, fine tuning or hyperparameter tuning, ensemble learning, etc. The criteria setting unit 12a may be configured as a generation AI for generating the criteria datum.

The encryption unit 13 is configured to output the personal information data Dp sorted by the sorting unit 12 as an encrypted personal information data Dpe by encrypting the personal information data Dp using various encryption techniques that are already or will be developed. The sorted personal information data Dp can be said to be personal information data Dp to be encrypted. As an example of encryption technology, secure computation such as homomorphic encryption and secure distributed encryption can be mentioned.

Holding unit 14 includes a memory or the like of a plurality of computers housed in a network and is configured using existing or upgraded blockchain technology. Holding unit 14 holds in the blockchain AI learn data of the status including the enciphered personal information Dpe either sequentially or at appropriate timing-intervals. That is, the holding unit 14 holds AI learning data including two kinds of data, an encrypted personal information data Dpe and an unencrypted personal information data Dn, in a block chain. A personal information data Dn that is not encrypted is data that can be treated as “non-personal information data”.

The AI learning unit 15 is configured to learn an AI model by performing secure calculations on the AI learning data (i.e., encrypted personal information data Dpe and unencrypted personal information data Dn) stored in the blockchain by the holding unit 14 using the secure calculation unit 15a, at least for the data portion relating to the encrypted personal information Dpe.

The AI learning unit 15 may be configured to perform AI learning using a supervised learning method, an unsupervised learning method, a semi-supervised learning method, a reinforcement learning method, a generative AI method, or the like, and to provide the learned AI models sequentially or collectively to a destination via a network. AI learning unit 15 may be configured using a neural neural network that performs efficient AI learning by expression learning, transfer learning, feature selection, fine tuning or hyperparameter tuning, ensemble learning, or the like. Alternatively, AI learning unit 15 may be configured as a generation AI that learns a pattern or a relation of the AI learning data and generates content data differing from the AI learning data. In either case, since the criteria setting by the criteria setting unit 12a in the sorting unit 12 is performed, the computation processing amount in the secure computing unit 15a is small compared to the case where the criteria setting is not performed. The secure computation here is, for example, a secure computation such as a perfectly homomorphic encryption method or a homomorphic encryption method and a secure distribution method. In particular, when the criteria setting unit 12a in the sorting unit 12 sets the criteria by AI learning, the further the learning proceeds, the less the computation processing of the secure computation is, which is advantageous in practice.

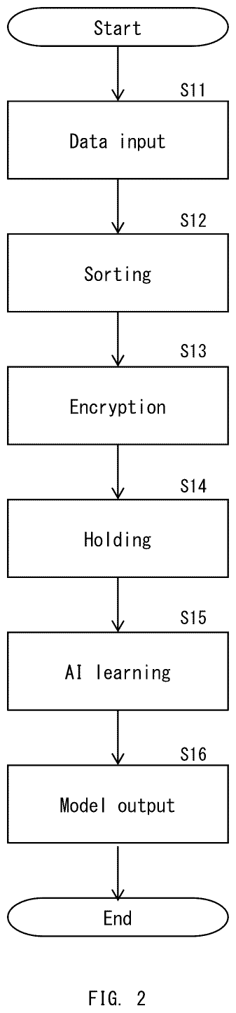

Next, referring to the flow charts of FIGS. 2, 3, and 4 in addition to the block diagram of FIG. 1, an exemplary processing in AI learning system according to the present embodiment will be described.

In FIG. 2, first, AI learning system 10 (see FIG. 1) receives AI learning data relating to personal information that has been converted into textualized or coded in a predetermined format from a data source accommodated on a network (step S11). Such AI learning data may include image data or video data.

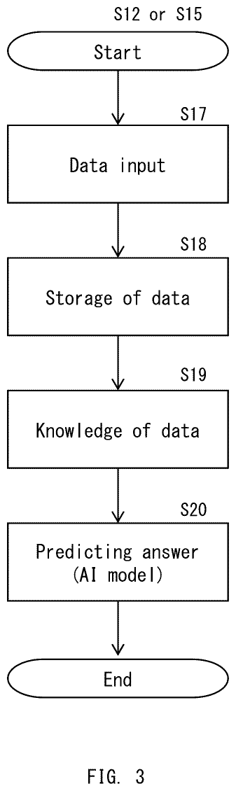

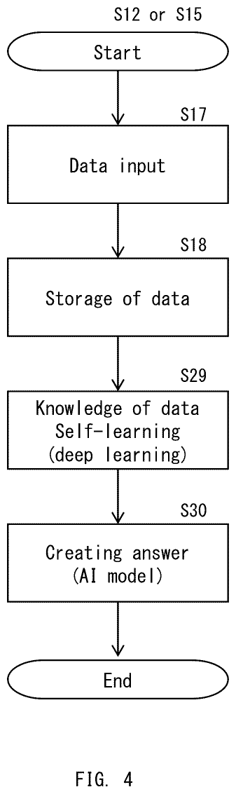

Next, the sorting unit 12 (see FIG. 1) sorts the personal information Dp to be secret in creating a desired AI model from AI learning data according to prescribed criteria (step S12). In particular, the prescribed criteria are set so that the computation processing is reduced according to the degree of increase or decrease in amount of processing and the degree of concealment of the personal information by encrypting the personal information. Such criteria are preferably set by AI learning (see FIGS. 3 and 4) as described below.

Next, the encryption unit 13 (see FIG. 1) encrypts the personal information data Dp selected to be encrypted by various encryption techniques and outputs it as an encrypted personal information data Dpe (step S13).

Next, the holding unit 14 (see FIG. 1) holds AI learning data including the enciphered personal information data Dpe and the non-enciphered personal information data Dn in the blockchain (S14).

Next, the AI learning unit 15 (see FIG. 1) learns the AI model by performing secure calculations on the AI learning data stored in the blockchain, at least for the data portion relating to the encrypted personal information Dpe, using its secure calculation unit 15a (see FIG. 1) (step S15). The secure computation may employ the secure computation of a fully homomorphic or homomorphic encryption that performs the computation while the encrypted personal information Dpe remains encrypted. Alternatively, the secrecy computation may employ a secrecy computation in a secure sharing scheme in which the enciphered personal-information-data Dpe is divided into pieces (shares) of some random numbers that themselves are not meaningful. Further, such AI learning unit 15 processing is preferably performed by AI learning as described later (see FIGS. 3 and 4).

Next, the predicted or created AI is outputted to the providing destination (step S16), and the series of processing is terminated.

The sorting processing (step S12) and AI learning (step S15) described above are each performed, for example, by traditional AI learning which is not a generation AI as shown in FIG. 3 or by AI learning using a generation AI as shown in FIG. 4.

In other words, as shown in FIG. 3, in an exemplary sorting processing (step S12), various AI learning data related to personal information are inputted (step S17). Storage of AI learning data is executed (step S18). Knowledge generation of AI learning data is performed (step S19). The appropriate answer, AI model, is predicted (step S20), and the existing content is output. In particular, the prescribed criteria are predicted as AI model so that the amount of computation processing becomes smaller according to the degree of increase or decrease in amount of processing and the degree of concealment of the personal information by encrypting the personal information. In this case, the rule making in setting prescribed criteria may be performed. For example, prescribed criteria may be set to screen target of the encryption so that a personally identifiable combination of personal information does not occur. Personal information which may be acceptable without being encrypted for the purpose of AI learning system 10 may be entered as teacher data. The prescribed criteria may be set so as to avoid encryption that results in an excessively large amount of computational processing in the secure computation as much as possible, and accept encryption that results in a smaller amount of computational processing in secure computation preferentially.

On the other hand, as shown in FIG. 3, in one exemplary AI learning (step S15), the encrypted personal information data Dpe and the unencrypted personal information data Dn are inputted for learning (step S17). Storage of AI learning-data (step S18) and knowledgeable (step S19) are performed to predict AI model as the appropriate answer (step S20). Then, the outputting of the existing contents is executed in the step S16 of FIG. 2. The calculations relating storage and knowledgeable of the data, and predicting AI model in steps S18 to S20 are processed by the secure computation on the encrypted personal information data Dpe which remains encrypted.

Alternatively, as shown in FIG. 4, in another embodiment of the sorting processing (step S12), various AI learning data relating to personal information is inputted (step S17), and AI learning data is stored (step S18). Knowledge of AI learning data and its own learning by deep learning are carried out (step S29), and AI model which is an appropriate answer is created (step S30). Then, the output of the original content which is not the existing content is performed. In particular, the prescribed criteria are created as AI model so that the computation processing amount is reduced according to the degree of increase or decrease in amount of processing and the degree of concealment of the personal information by encrypting the personal information. For example, deep learning may be done about avoiding personally identifiable combinations of personal information, preferentially allowing encryption that results in less processing of secure computation, and so on.

On the other hand, as shown in FIG. 4, in another example of AI learning (step S15), the encrypted personal information data Dpe and the unencrypted personal information data Dn are inputted as AI learning data (step S17), and AI learning data is stored (step S18). Knowledge of AI learning data and its own learning by deep learning are carried out (step S29), and AI model which is an appropriate answer is created (step S30). Then, the output of the original contents that are not the existing contents is executed in the step S16 of FIG. 2. The calculations relating storage, knowledgeable, and deep learning of the data and the creation of AI model in steps S18 to S30 are processed by secure computation on the encrypted personal informational data Dpe which remains encrypted.

As described above, the personal information to be secret among AI learning data is sorted and encrypted, and the data is retained using the blockchain technique, and AI learning is performed using the secure computation technique. Therefore, even if the personal information data is stored for a relatively long period of time and is therefore in an environment where confidentiality is inherently difficult to maintain, staff of the corporation or the like using AI learning system 10 are prevented from viewing the personal information data Dpe or AI model as information that can identify an individual related to the personal information. Furthermore, it becomes very difficult to view individuals related to personal information in the form of identifiable information. As a result, it is possible to effectively prevent personal information from being leaked to third party, while also providing customized value to the owner of the personal information through AI learning that utilizes the personal information.

### (Supplementary Notes)

With respect to the example embodiments described above, the following Supplementary Notes are further disclosed.

### [Supplementary Note 1]

An AI learning system comprising:
a sorter configured to sort, from among AI learning data, personal information that should be secret when creating a desired AI model, according to prescribed criteria;
an encryptor configured to encrypts the sorted personal information;
a holder configured to hold the AI learning data including the encrypted personal information in a blockchain; and
an AI learner configured to perform secret calculations on at least the data portion related to encrypted the personal information to learn the AI model, using the stored AI learning data; wherein the sorting unit sets the prescribed criteria so as to reduce amount of calculation processing, depending on the degree of increase or decrease in the amount of calculation processing of the secure computation due to encryption of the personal information and the degree to which the personal information should be secret.

According to AI learning system of supplementary note 1, the personal information to be secret among AI learning data is sorted and encrypted. In addition, AI learning data in which encrypted personal information is included is held in the block chain. Using the AI learning data stored in this manner, AI model is learned by performing secure computation on at least encrypted data portion related to personal information. The above screening shall be carried out by setting prescribed criteria so that the amount of calculation processing is small in accordance with the degree of increase or decrease in the amount of processing and the degree of concealment of the personal information by encrypting personal information. This is possible to effectively prevent personal information from being leaked to third party, while also providing customized value to the owner of the personal information through AI learning that utilizes the personal information.

### [Supplementary Note 2]

The AI learning system according to Supplementary Note 1, wherein the sorting unit sets the prescribed criteria and sorts the personal information by AI learning using the degree of increase/decrease in the amount of calculation processing and the degree to which the personal information should be secret as AI learning data.

According to AI learning system described in supplementary note 2 according to the present invention, in the sorting unit, prescribed criteria as described above is set by AI learning. Therefore, the more AI learning progresses in the sorting unit, the larger the number of samples or the scale of learning for AI learning data related to the computation processing amount in secure computation and AI learning data related to the confidentiality of personal information will be, making it possible to set more appropriate prescribed criteria. Therefore, it is very advantageous in reducing the computation processing amount while ensuring the concealment property.

The present invention can be modified as appropriate within the scope that does not contradict the gist or concept of the invention that can be read from the claims and the entire specification, and an AI learning system involving such modifications is also included in the technical concept of the present invention.

### DESCRIPTION OF REFERENCE NUMERALS

AI learning system . . . 10
Sorting unit . . . 12
Encryption unit . . . 13
Holding unit . . . 14
AI learning unit . . . 15

What is claimed is:

1. An AI learning system comprising:
a sorter configured to sort, from among AI learning data, personal information that should be secret when creating a desired AI model, according to prescribed criteria;
an encryptor configured to encrypts the sorted personal information;
a holder configured to hold the AI learning data including the encrypted personal information in a blockchain; and
an AI learner configured to perform secret calculations on at least the data portion related to encrypted the personal information to learn the AI model, using the stored AI learning data;
wherein the sorting unit sets the prescribed criteria so as to reduce amount of calculation processing, depending on the degree of increase or decrease in the amount of calculation processing of the secure computation due to encryption of the personal information and the degree to which the personal information should be secret.

2. The AI learning system according to claim 1, wherein the sorting unit sets the prescribed criteria and sorts the personal information by AI learning using the degree of increase/decrease in the amount of calculation processing and the degree to which the personal information should be secret as AI learning data.
